(19) United States
(12) Patent Application Publication
(10) Pub. No.: US 2026/0056997 A1
(43) Pub. Date: Feb. 26, 2026

(54) SYSTEMS AND METHODS FOR REPRESENTATION LEARNING FOR NEW PRODUCT INTRODUCTION

(71) Applicant: Kinaxis Inc, Ottawa (CA)

(72) Inventors: Sebastien Ouellet, Ottawa (CA); Ozgun Ozan Kilic, Ottawa (CA)

(73) Assignee: Kinaxis Inc, Ottawa, ON (CA)

(21) Appl. No.: 19/307,785

(22) Filed: Aug. 22, 2025

Related U.S. Application Data
(60) Provisional application No. 63/685,921, filed on Aug. 22, 2024.

(51) Int. Cl. G06F 16/334; G06Q 30/0601

(52) U.S. Cl. CPC G06F 16/3347; G06Q 30/0631

(57) ABSTRACT

A deep learning model that learns a non-linear mathematical function that maps vector representations of products obtained from their characteristics known before launch, to a new numerical space where pair-wise product demand similarities can be inferred from their newly learned dense vector representations. The non-linear mapping between different numerical spaces can be optimized such that two products that have a small demand difference, also have a small cosine distance between their respective vector representations, even if their characteristics are not all that similar. The inferred demand similarities can be used to provide surrogate product recommendations that may be used to predict initial demand volume within a new product's launch period.

### INTRODUCTION

This application claims priority to U.S. Provisional Patent Application No. 63/685,921, filed Aug. 22, 2024, which is incorporated herein by reference in its entirety.

### BACKGROUND

Demand forecasting for a given product primarily relies on historical demand data of the product, which is not available when a new product is introduced. A common approach for forecasting demand of a new product is choosing one or more surrogate products (or “surrogate”) for use in the prediction. Such surrogates are selected by domain experts, with the expectation that the new product will have similar demand values to the demand of the surrogate product during the launch period of the surrogate.

Selecting one or more surrogates is not an easy task due to the sheer number of available products, thereby requiring domain knowledge and manual labor. There is also the fact that name-wise or category-wise, most similar-looking products may not always have (the most) similar demands.

There is a need for an automated method that can make surrogate product recommendations optimized for demand similarity, while working with product characteristics known before the product's launch.

### BRIEF SUMMARY

Systems and methods disclosed herein can include a solution that learns a non-linear mathematical function that maps vector representations of products obtained from their characteristics known before launch, to a new numerical space where pair-wise product demand similarities can be inferred from their newly learned dense vector representations. The non-linear mapping between different numerical spaces can be optimized such that two products that have a small demand difference, also have a small cosine distance between their respective vector representations, even if their characteristics are not all that similar. The inferred demand similarities can be used to provide surrogate product recommendations that may be used to predict initial demand volume within a new product's launch period.

In one aspect, a computing apparatus Is provided, that includes a processor. The computing apparatus also includes a memory storing instructions that, when executed by the processor, configure the apparatus to train a text embedding model to provide a trained embedding model, generate a vector representation for an existing product, obtain a demand difference among each existing product pair, map the demand difference to a metric similarity score, create a deep neural network, train the deep neural network to learn a mapping from the vector representation to a learned representation such that similarity between a pair of learned representation reflects the mapped similarity score of the pair, store a learned vector representation of each existing product, compare the learned vector representations of existing products with a learned vector representation of a new product, and select an optimal surrogate product based on a cosine similarity ranking.

When generating the vector representation, the apparatus may be further configured to provide one or more textual descriptions of the existing product to the trained embedding model, obtain from the trained embedding model, one or more vectors that correspond to each of the one or more textual descriptions, provide one or more non-textual features of the existing product in a vector format, concatenate the one or more vectors and the non-textual features in the vector format, to provide the vector representation of the existing product.

When mapping, the apparatus may be further configured to inversely map a demand difference to a cosine similarity range.

The computing apparatus may also include where the deep neural network has at least two hidden layers and a rectified linear unit activation function between each hidden layer. The computing apparatus may also include where a Siamese network approach is used to train the deep neural network. The computing apparatus may also include where a loss function implemented in the deep neural network is based on contrastive learn principles. The computing apparatus may also include where one or more categorical features are used at least one of before and after representation learn, for selecting the optimal surrogate product. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to train a text embedding model to provide a trained embedding model, generate a vector representation for an existing product, obtain a demand difference among each existing product pair, map the demand difference to a metric similarity score, create a deep neural network, train the deep neural network to learn a mapping from the vector representation to a learned representation such that similarity between a pair of learned representation reflects the mapped similarity score of the pair, store a learned vector representation of each existing product, compare the learned vector representations of existing products with a learned vector representation of a new product, and select an optimal surrogate product based on a cosine similarity ranking.

When generating the vector representation, the computer may be further configured to provide one or more textual descriptions of the existing product to the trained embedding model, obtain from the trained embedding model, one or more vectors that correspond to each of the one or more textual descriptions, provide one or more non-textual features of the existing product in a vector format, concatenate the one or more vectors and the non-textual features in the vector format, to provide the vector representation of the existing product.

When mapping, the computer may be further configured to inversely map a demand difference to a cosine similarity range. The non-transitory computer-readable storage medium may also include where the deep neural network has at least two hidden layers and a rectified linear unit activation function between each hidden layer. The non-transitory computer-readable storage medium may also include where a Siamese network approach is used to train the deep neural network. The non-transitory computer-readable storage medium may also include where a loss function implemented in the deep neural network is based on contrastive learn principles. The non-transitory computer-readable storage medium may also include where one or more categorical features are used at least one of before and after representation learn, for selecting the optimal surrogate product. Other technical features may be readily apparent to one skilled in the art from the following figures, descriptions, and claims.

In one aspect, a computer-implemented method includes training, by a processor, a text embedding model to provide a trained embedding model, generating, by the processor, a vector representation for an existing product, obtaining, by the processor, a demand difference among each existing product pair, mapping, by the processor, the demand difference to a metric similarity score, creating, by the processor, a deep neural network, training, by the processor, the deep neural network to learn a mapping from the vector representation to a learned representation such that similarity between a pair of learned representation reflects the mapped similarity score of the pair, storing, by the processor, a learned vector representation of each existing product, comparing, by the processor, the learned vector representations of existing products with a learned vector representation of a new product, and selecting, by the processor, an optimal surrogate product based on a cosine similarity ranking.

The computer-implemented method may also include where generating the vector representation includes providing, by the processor, one or more textual descriptions of the existing product to the trained embedding model, obtaining, by the processor, from the trained embedding model, one or more vectors that correspond to each of the one or more textual descriptions, providing, by the processor, one or more non-textual features of the existing product in a vector format, concatenating, by the processor, the one or more vectors and the non-textual features in the vector format, to provide the vector representation of the existing product.

The computer-implemented method may also include where mapping includes inversely mapping, by the processor, a demand difference to a cosine similarity range. The computer-implemented method may also include where the deep neural network has at least two hidden layers and a rectified linear unit activation function between each hidden layer. The computer-implemented method may also include where a Siamese network approach is used to train the deep neural network. The computer-implemented method may also include where a loss function implemented in the deep neural network is based on contrastive learning principles. The computer-implemented method may also include where one or more categorical features are used at least one of before and after representation learning, for selecting the optimal surrogate product. Other technical features may be readily apparent to one skilled in the art from the following figures, descriptions, and claims.

In one aspect, a machine learning model is provided, that includes: an embedding component configured to generate representations of products from product characteristics, a mapping component configured to associate product demand information with similarity scores, and a training component configured to learn a transformation from the representations to learned representations such that similarity between learned representations reflects the similarity scores, where the machine learning model is configured to generate a learned representation for a product. Other technical features may be readily apparent to one skilled in the art from the following figures, descriptions, and claims.

In one aspect, a system includes at least one processor and a memory storing instructions that, when executed by the at least one processor, cause the system to: generate a vector representation for a product using one or more characteristics of the product known before launch of the product, obtain demand differences among pairs of existing products, map demand differences to similarity scores, train a deep neural network to learn a mapping from the vector representation to a learned representation such that similarity between the learned representation reflects the mapped similarity scores, store the learned representation for each product, generate a learned representation for a new product, compare the learned representation of the new product with the learned representation of each product, and select one or more products as a surrogate product for the new product, based on the comparison.

The system may also include wherein the one or more characteristics of the product comprise at least one of: product category, physical attributes, intended use, or target customer segment. The system may also include where the demand differences among pairs of existing products are determined based on historical sales data. The system may also include where the similarity scores are computed using a distance metric selected from the group consisting of: Euclidean distance, cosine similarity, and Manhattan distance. The system may also include where the model is a neural network trained using supervised learning. The system may also include wherein generating the learned representation for a new product further includes applying the trained model to the vector representation of the new product. The system may also include where comparing the learned representation of the new product with the learned representation of each product includes calculating a similarity score for each comparison. The system may also include wherein selecting one or more products as a surrogate product includes selecting the product or products having the highest similarity scores to the new product. The system may also include wherein the system further includes displaying the selected surrogate product or products to a user via a graphical user interface. The system may also include where the memory further stores instructions that, when executed, cause the system to update the model based on feedback received from users regarding the accuracy of the surrogate product selection. Other technical features may be readily apparent to one skilled in the art from the following figures, descriptions, and claims.

In one aspect, a computer-implemented method includes generating, by a processor, a vector representation for a product using one or more characteristics of the product known before launch of the product, obtaining, by the processor, demand differences among pairs of existing products, mapping, by the processor, demand differences to similarity scores, training, by the processor, a deep neural network to learn a mapping from the vector representation to a learned representation such that similarity between the learned representation reflects the mapped similarity scores, storing, by the processor, the learned representation for each product, generating, by the processor, a learned representation for a new product, comparing by the processor, the learned representation of the new product with the learned representation of each product, and selecting, by the processor, one or more products as a surrogate product for the new product, based on the comparison. Other technical features may be readily apparent to one skilled in the art from the following figures, descriptions, and claims.

In one aspect, a non-transitory computer-readable storage medium, the computer-readable storage medium including instructions that when executed by a computer, cause the computer to generate a vector representation for a product using one or more characteristics of the product known before launch of the product, obtain demand differences among pairs of existing products, map demand differences to similarity scores, train a deep neural network to learn a mapping from the vector representation to a learned representation such that similarity between the learned representation reflects the mapped similarity scores, store the learned representation for each product, generate a learned representation for a new product, compare the learned representation of the new product with the learned representation of each product, and select one or more products as a surrogate product for the new product, based on the comparison. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for representation learning for new product introduction, in accordance with one embodiment.

FIG. 2 illustrates a block diagram of representation learning for new product introduction, in accordance with one embodiment.

FIG. 3 illustrates a series of steps for obtaining a learned vector reorientation of an existing product from characteristics and additional features each product, in accordance with one embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit including custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, include one or more physical or logical blocks of computer instructions which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object-oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which includes one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random-access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

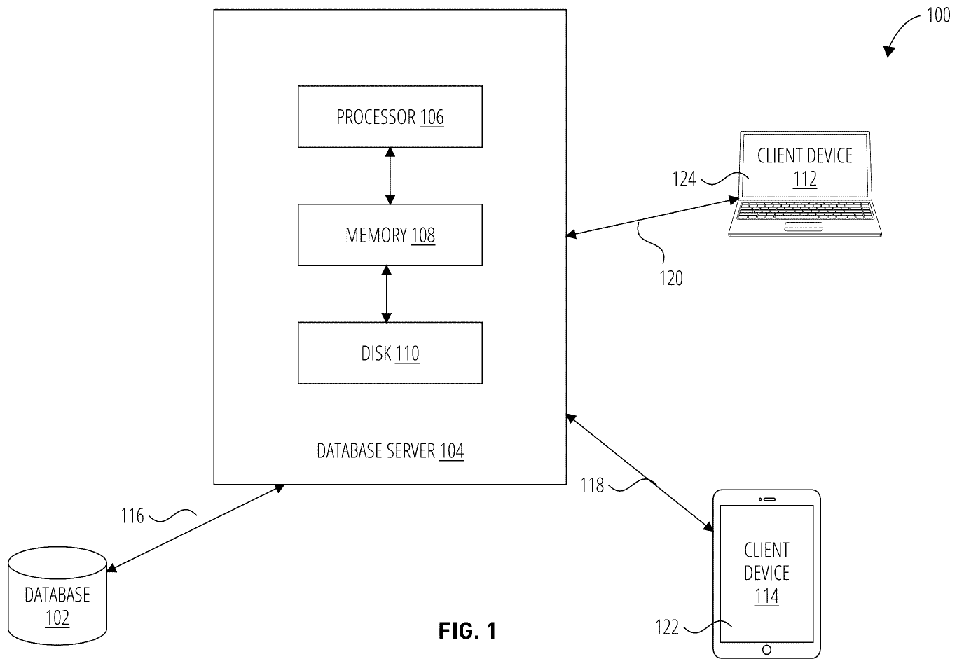

FIG. 1 illustrates an example of a system 100 for representation learning for new product introduction, in accordance with one embodiment.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also include a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

Systems and methods for representation learning disclosed herein can include a number of elements, a few of which are listed as follows.
1) Historical demand data of existing products (that is, surrogacy candidates), including, historical demand data during the launch period of each surrogacy candidate. Demand data is used to train the deep neural network for representation learning.
2) In addition, various characteristic details of existing and new products are used to obtain initial vector representation of each product. This initial representation is discussed further below, and can include numerical representations.
3) An embedding model that can obtain vector representations of existing and new products from textual descriptions and other characteristics of each type of product.
4) A deep neural network model to learn a non-linear mapping function from one vector space to another vector space. Here, pairs of initial vector representations are input to the deep neural network, which uses the respective demand data difference between each vector pairs, to eventually transform an initial vector representation to a learned vector representation of each existing product.

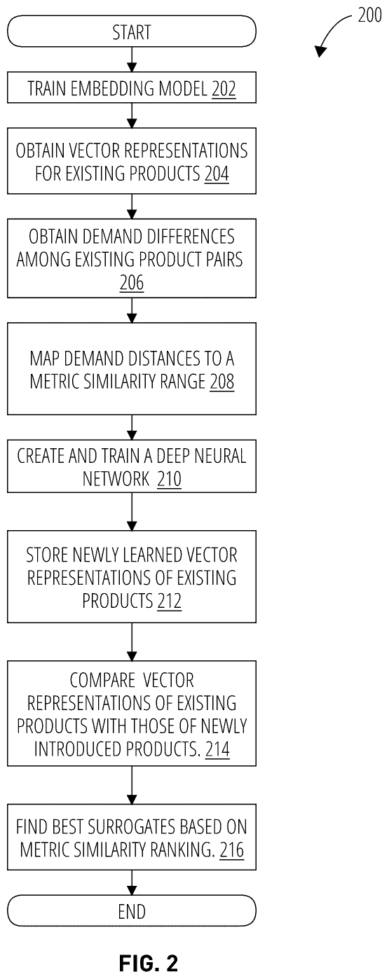

FIG. 2 illustrates a block diagram 200 of representation learning for new product introduction, in accordance with one embodiment.

At block 202, an embedding model is trained to provide a vector representation of a product, based on product characteristics. Alternatively, a pre-trained, embedding model can be used. The greater the similarity in textual characteristic descriptions between two products, the lower the cosine distance between the vector representations of the two products.

Once the embedding model is trained at block 202, a vector representation of each existing product, based on its characteristics, is obtained at block 204. Here, the vector representation for each existing product is obtained using the text embedding model (trained at block 202) and product characteristics of each product before its launch. Textual information can be separately embedded and then concatenated together, while non-textual characteristics may be vectorized (if needed) and later concatenated to the vector representation, as one or more new dimensions. The concatenated vector can be a combination of dense and sparse vectors.

Next, at block 206, using a defined launch period, demand data of all of the products corresponding to their launch period is retrieved. This demand data can be represented as a time series. A pair-wise demand distance can be calculated for each product pair using an error metric. One example of an error metric is symmetrical mean absolute percentage error.

At block 208, the process maps demand similarities among the existing products to a target metric similarity range, in which the target metric provides a measure between vector representations of two product. As an example, the process can map demand similarities among the existing products to a target cosine similarity range (between −1 and +1) so that the lowest demand distance corresponds to the highest cosine similarity and the highest demand distance corresponds to the lowest cosine similarity. Here, demand distance refers to a metric that provides a measure of the difference between demand data (at launch) of two different products.

A deep neural network is created and trained at block 210. In some embodiments, the deep neural network has at least two hidden layers and a rectified linear unit activation function between each layer. In other embodiments, the deep neural network has less than two hidden layer. In some embodiments, regardless of the number of hidden layers, other activation functions are used. In other embodiments, the deep neural network can have other types of layers, such as dropout, pooling, and the like. Input of this model can be the original vector representations.

Output of the model includes the newly-learned dense vector representations. Using the target pseudo-cosine similarities (mapped demand similarities), this new model can be trained in a Siamese fashion, such that, the squared difference between a target cosine similarity and the observed cosine similarity calculated with products' new embeddings from the new model, is minimized. Other alternative contrastive learning approaches can also be used. This new embedding model obtains such new embeddings for each product that demand-wise similar products have high cosine similarity, while dissimilar products have low cosine similarity.

The newly learned vector representations obtained for each existing product are stored at block 212, for later use. At block 214, for each new product that is to be launched, the top surrogate candidate(s) are found either exhaustively or approximately using the stored vector representations (from block 212) and the new vector representation obtained for the new product. Additional similarity metrics can be combined with the embedding similarity to give weight to other factors. Demand values of multiple surrogates can be time-wise averaged.

The best surrogate(s) can be found at block 216, based on the metric similarity ranking. As discussed with respect to block 208, the metric similarity ranking can be a cosine similarity ranking.

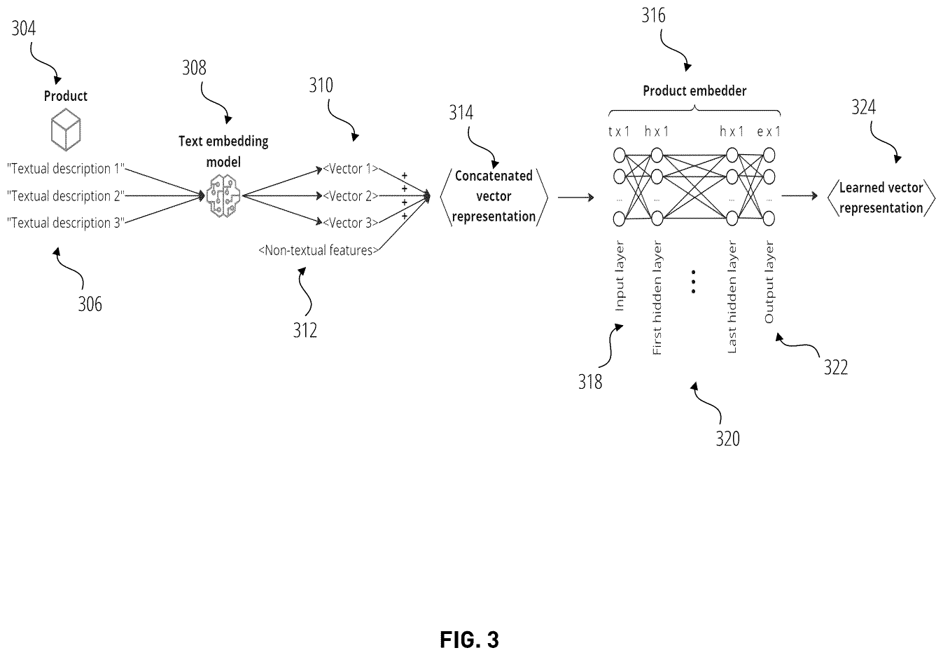

FIG. 3 illustrates a series of steps for obtaining a learned vector reorientation of an existing product from characteristics and additional features each product, in accordance with one embodiment.

Methods and systems disclosed herein may be described as “contrastive representation learning”. The model constructed herein, learns to represent products by comparing them with each other and converge towards a function that yields representations from which demand similarity can be correctly inferred.

Different textual descriptions 306 of a product 304 are separately fed to a text embedding model 308. Textual descriptions can provide different kinds of information about a product, such as product name, brand name, category name, and the like. A text embedding model 308 is used since relevant information regarding product 304 is textual.

On the other hand, if the product can be adequately described by categorical information, one-hot encoding can be used, where there are ‘n’ dimensions for ‘n’ different categories, and each dimension is an indicator of whether the product belongs to that category. For example, if there is a feature that can take one of three possible categories, this feature can be one-hot-encoded using a vector of three dimensions. A product having vector <1, 0, 0> would mean that the product's value is whatever value is associated with the first dimension.

Since it is not possible to efficiently represent a sentence, or textual description, using one-hot encoding, a dense vector representation of the sentence can be used instead. An example of a dense vector representation is as follows: <0.4563, 1.4623, 2.1021, . . . , 0.0102>. It may not look sensible to the human eye. However, the text embedding model 308 is fed so much information that it makes sense of how things fit in a bigger picture. The text embedding model 308 finds its own way to represent entities, which is different than how humans perceive them. An advantage of these representations, is the case with which they can be measured and their similarity compared.

Different types of features 312 can be concatenated before being fed as a single concatenated vector 314 to a product embedding model 316 (which is a deep neural network). For example, if there are three textual features (or descriptions) and each feature is represented by a vector of ‘x’ dimensions, and subsequently, a vector (312) of ‘y’ dimensions having non-textual features is added, the concatenated vector 314 representation has (x*3)+y dimensions. While 3 textual descriptions are shown in FIG. 3, it is understood that each product can have fewer than, or more than 3. In general for ‘m’ textual descriptions, the concatenated vector 314 representation has ‘m*x+y’ dimensions.

Dense vector representations do not need to have the same vector dimensions. As an analogy, an item's color can be explained with one word, whereas the items shape can be explained in two words or more. This is possible, even without using different embedding models, since the text embedding model can use “matryoshka embedding.” This method can be used to efficiently obtain the ‘n’ most important/basic dimensions instead of the entire space for representation.

Given that there are ‘m*x+y’ dimensions in a vector representation (314) of product 304, an input layer 318 of the product embedding model 316 also has the same size ‘t’ (t=m*x+y). The dimension ‘h’ of the hidden layers 320 and the dimension ‘e’ of the output layer 322, on the other hand, can be different from the dimension ‘t’ of the input layer 318. Increasing the hidden/output layer sizes allows for representation in greater detail (that is, there is more space to differentiate two entities further). In an example, there are 768 dimensions per textual description. However, there is no fixed rule about the dimension size. Experimentally, different values have been tried, with a small portion of data used for validation, while case-specific decisions can be made.

The number of hidden layers 320 also has no fixed rule; the number is often case-specific. In some embodiments, 2-5 hidden layers are used; however the number of hidden layers depends on the specific embodiment. However, one single hidden layer can be enough in some embodiments.

The most common training method in deep learning is comparing the model's output with a ground truth. For example, the model can be fed an image and then predict whether a cat or a dog was present in the image. While training the product embedding model 316, the process incrementally changes and optimizes the embeddings obtained through the model 316 for the same product, because the model 316 learns to represent products (as vectors) in a better way (which makes the embedding similarity between two products mirror their demand similarity). Thus, the product embedding model 316 itself does not answer whether two products are similar or not; rather it learns to embed products efficiently.

These representations for different product pairs are obtained, separately feeding two products to the model and obtaining their learned vector representations 324. The similarity measured from these vectors can then be compared with a target similarity. This approach is also known as a “Siamese network.”

In some embodiments, dense vector representations are obtained separately for each textual description 306 (as an example: “Brand 1”, “Product 1”, “Category 1”). Subsequently, these vectors are concatenated to obtain a concatenated vector representation 314 of the product 304. If a product does not have one of the textual representation, the product then has a vector full of zeros for that specific description. As an alternative, it is possible to first concatenate these different textual descriptions 306 with, or without, a separator (like “Brand 1 Product 1 Category 1” or “Brand 1 | Product 1 | Category 1”) and then obtain the vector representation directly from that one piece textual description 306. This approach can be more straightforward, and may yield smaller vector representations; however the information may become sort of entangled that way.

A contrastive mean square approach can be used as a loss function. However, it is possible to use other loss functions that are based on the contrastive learning principles, including but not limited to contrastive loss and triplet loss.

In order to find the ideal surrogate(s), the learned representation similarities are examined; the topmost similar ones are selected. However, it is possible to add additional similarity/relevance metrics and use a weighted combination of such metrics to rank the candidates. For example, a surrogate has a similarity of 70%, but its categorical similarity is 100%. The categorical similarity can be given a weight of 0.3 and therefore this candidate's weighted similarity is 70*0.7+100*0.3=79%. So, categorical features may be used before and/or after representation learning to guide the surrogate selection process.

This method can be used at the product level where surrogate products are recommended (without caring where the product is being introduced). Or at the product-customer level, where product-customer pairs are recommended for a given new product-customer pair. The latter may work better if a product is not new in Store A, but new for Store B, or if products can have wildly different demands in different stores. Surrogate selection may suggest using the same product's Store A demands as surrogate values to be used for Store B as well or find an even better product-customer surrogate (which human experts may miss due to focusing on the same product that was introduced before in another store).

Extra categorical data can also include component-like features. For example, it is possible to vectorize the possible parts that a product can have, and also feed it to the model. This way, the model could also see how the compositional structure of one model is similar with another product.

Extra features can include temporal features such as the holiday or promo indications for the forecasting window, and so forth.

For scalability purposes, it is possible to implement a solution using the learned representations of existing products (or product-customer pairs) so that approximately closest ones can be found very fast. This solution may involve processes such as an approximate nearest neighbor search, dimensionality reduction, parallelization, and so on.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computing apparatus comprising:
a processor; and
a memory storing instructions that, when executed by the processor, configure the apparatus to:
train a text embedding model to provide a trained embedding model;
generate a vector representation for an existing product;
obtain a demand difference among each existing product pair;
map the demand difference to a metric similarity score;
create a deep neural network;
train the deep neural network to learn a mapping from the vector representation to a learned representation such that similarity between a pair of learned representation reflects the mapped similarity score of the pair;
store a learned vector representation of each existing product;
compare the learned vector representations of existing products with a learned vector representation of a new product; and
select an optimal surrogate product based on a cosine similarity ranking.

2. The computing apparatus of claim 1, wherein when generating the vector representation, the apparatus is further configured to:
provide one or more textual descriptions of the existing product to the trained embedding model;
obtain from the trained embedding model, one or more vectors that correspond to each of the one or more textual descriptions;
provide one or more non-textual features of the existing product in a vector format;
concatenate the one or more vectors and the non-textual features in the vector format, to provide the vector representation of the existing product.

3. The computing apparatus of claim 1, wherein when mapping, the apparatus is further configured to:
inversely map a demand difference to a cosine similarity range.

4. The computing apparatus of claim 1, wherein the deep neural network has at least two hidden layers and a rectified linear unit activation function between each hidden layer.

5. The computing apparatus of claim 1, wherein a Siamese network approach is used to train the deep neural network.

6. The computing apparatus of claim 1, wherein a loss function implemented in the deep neural network is based on contrastive learn principles.

7. The computing apparatus of claim 1, wherein one or more categorical features are used at least one of before and after representation learn, for selecting the optimal surrogate product.

8. A machine learning model comprising:
an embedding component configured to generate representations of products from product characteristics;
a mapping component configured to associate product demand information with similarity scores; and
a training component configured to learn a transformation from the representations to learned representations such that similarity between learned representations reflects the similarity scores;
wherein the machine learning model is configured to generate a learned representation for a product.

9. A system comprising at least one processor and a memory storing instructions that, when executed by the at least one processor, cause the system to:
generate a vector representation for a product using one or more characteristics of the product known before launch of the product;
obtain demand differences among pairs of existing products;
map demand differences to similarity scores;
train a deep neural network to learn a mapping from the vector representation to a learned representation such that similarity between the learned representation reflects the mapped similarity scores;
store the learned representation for each product;
generate a learned representation for a new product;
compare the learned representation of the new product with the learned representation of each product; and
select one or more products as a surrogate product for the new product, based on the comparison.

10. The system of claim 9, wherein the one or more characteristics of the product comprise at least one of: product category, physical attributes, intended use, or target customer segment.

11. The system of claim 9, wherein the demand differences among pairs of existing products are determined based on historical sales data.

12. The system of claim 9, wherein the similarity scores are computed using a distance metric selected from the group consisting of: Euclidean distance, cosine similarity, and Manhattan distance.

13. The system of claim 9, wherein the model is a neural network trained using supervised learning.

14. The system of claim 9, wherein generating the learned representation for a new product further comprises applying the trained model to the vector representation of the new product.

15. The system of claim 9, wherein comparing the learned representation of the new product with the learned representation of each product comprises calculating a similarity score for each comparison.

16. The system of claim 9, wherein selecting one or more products as a surrogate product comprises selecting the product or products having the highest similarity scores to the new product.

17. The system of claim 9, wherein the system further comprises displaying the selected surrogate product or products to a user via a graphical user interface.

18. The system of claim 9, wherein the memory further stores instructions that, when executed, cause the system to update the model based on feedback received from users regarding the accuracy of the surrogate product selection.
